(19) United States
(12) Patent Application Publication
(10) Pub. No.: US 2009/0301329 A1
(43) Pub. Date: Dec. 10, 2009

(54) SUPPORT FOR WRAPPING AN ABSORBING MATERIAL TO BE USED IN PRINTING MACHINE CLEANING PLANTS

(76) Inventor: Arrio Vavassori Bisutti, Bergamo (IT)

Correspondence Address: SCHNECK & SCHNECK, P.O. BOX 2-E, SAN JOSE, CA, 95109-0005, US

(21) Appl. No.: 12/441,188

(22) PCT Filed: Sep. 12, 2007
(86) PCT No.: PCT/IB07/02706

§ 371 Date: Apr. 8, 2009

(30) Foreign Application Priority Data
Sep. 15, 2006 (IT) MI2006U000321

(51) Int. Cl. B41F 35/00

(52) U.S. Cl. 101/425

(57) ABSTRACT

Support (10) for wrapping an absorbing material to be used into printing machine cleaning plants providing an exterior wrapping surface, characterized in that the interior surface (xx) of said support has anchoring elements (21) protruding with respect to said interior surface. The section of said anchoring elements has, through a perpendicular plane to the interior surface, at least one side forming an angle greater or equal to 90- with the interior surface.

### FIELD OF THE INVENTION

The present invention refers to a support for wrapping an absorbing material to be used in printing machine cleaning plants.

Recently made printing machines are provided with automatic cleaning systems which provide the use of an absorbing material packaged in rolls having the same width as the printing machine. Such absorbing material rolls are placed into the automatic device, which is aimed to unwrap the roll, spray the absorbing material with a solvent for printing inks, and place the solvent-soaked absorbing material into contact with the machine ink-soiled cylinders, making them spin.

Thanks to said contact between the solvent-soaked absorbing material and the inked cylinders of the machine, the cylinders are cleaned by transfer of ink from cylinders to the solvent-soaked absorbing material; the ink-soiled absorbing material is then newly wrapped on a shaft of the automatic system, while when a cleaning operation is wanted, the clean absorbing material still available on the roll is unwrapped, sprayed with solvent and put into contact with the ink-soiled cylinder of the printing machine.

By said process, which prolongs until the end of the absorbing material wrapped on the roll, various cycles of total cleaning of cylinders and printing fabrics are obtained.

A more complex automatic cleaning system provides the use of absorbing material rolls previously soaked with solvent. Such rolls are placed into an automatic device consisting of an apparatus only provided with a device for unwrapping the clean absorbing material and newly wrapping the soiled absorbing material. The device used with such a system is much more simple since the use of pre-soaked absorbing material does not require any solvent tank, distribution pumps, spraying nozzles, and systems for recovering exhaust or exceeding solvent.

In all the above cited cases, during cleaning operations the roll is subjected to a strong traction in order to assure a perfect contact between the material and the ink-soiled fabric surface or printing machine cylinder.

The main printing machine cleaning systems of prior art are provided with devices suited to lock the absorbing material roll as well as to allow the absorbing material wrapping and unwrapping movements.

Other cleaning systems of the prior art are rather provided with properly knurled shafts around which the absorbing material is directly wrapped.

Such systems do not require further supports for wrapping the absorbing material; however, the worker who sets up the plant necessarily tends to wrap the absorbing material on the knurled shaft before each cleaning operation, and to unwrap it when said absorbing material has been completely used, substituting it with a clean new one.

The limitations of such systems are several and well understandable.

Above all, the above manual operations of wrapping and unwrapping the absorbing material to the knurled shaft involve notable downtimes of the plant.

Moreover, the workers who perform such operations come into contact with potentially harmful substances, such as solvents and inks used in the printing process, which are on the absorbing material used to clean the printing cylinders. Such an opportunity is undoubtedly undesirable to guarantee a proper tutelage of the working environment health conditions.

Finally, the long downtimes and the need to use qualified personnel lead to high manufacturing costs.

The aim of the present invention is therefore to solve the above said problems by making a support for wrapping the absorbing material to be used in printing machine cleaning plants, which can be used in existing plants reducing the set up times while assuring an optimal sizing of the system with respect to those forces applied on said support during cleaning operations.

Another aim of the present invention is to create a support for wrapping the absorbing material to be used in printing machine cleaning plants, which can allow a time reduction of the manual operations performed by the workers into the cleaning plant.

A further aim of the present invention is to make a support for wrapping the absorbing material to be used in printing machine cleaning plants, which improves the health conditions of the working environment.

Finally, an aim of the present invention is to make a support for wrapping the absorbing material to be used in printing machine cleaning plants, which involves a reduction of manufacturing costs.

Such aims are reached by a support for wrapping the absorbing material as referred to in claim 1, to which we refer for shortness reasons.

The invention is thereafter described in detail, by way of non limiting examples, with reference to the appended drawings, in which:

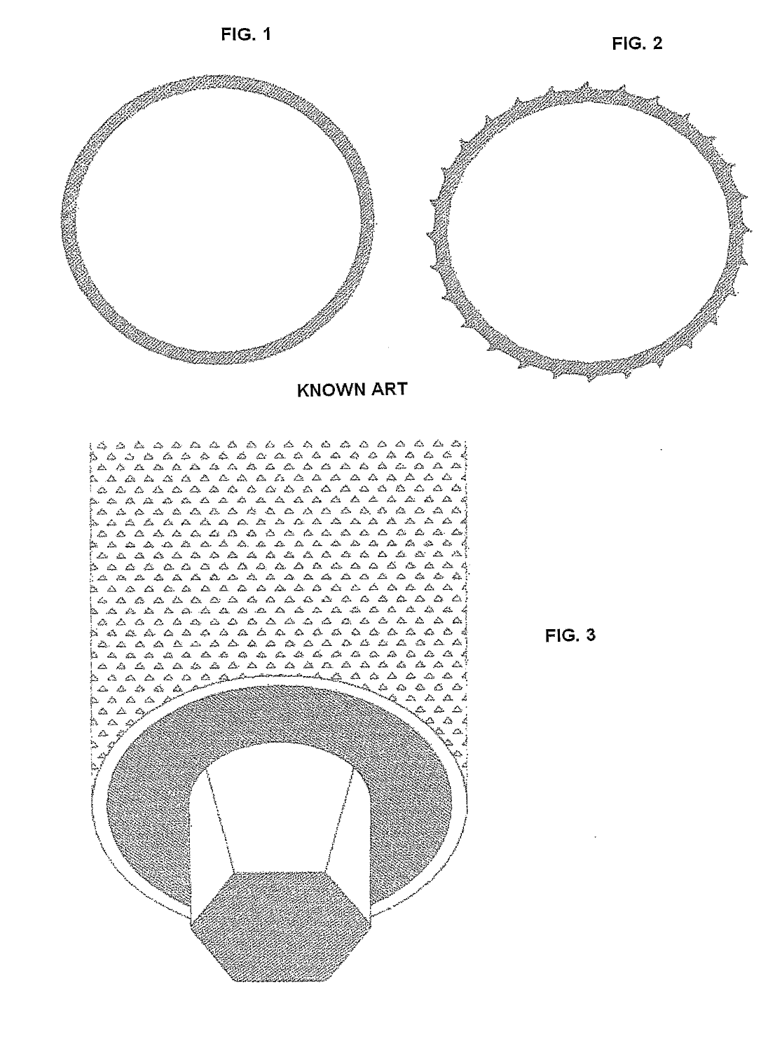

FIG. 1 shows a sectional view of a support for an absorbing material through a perpendicular plane to said support axe, according to the known art;

FIG. 2 shows a sectional view of a first embodiment of the support for an absorbing material through a perpendicular plane to said support axe, according to the present invention;

FIG. 3, shows an axonometric view of a knurled shaft portion, as used in printing machine cleaning systems according to the known art;

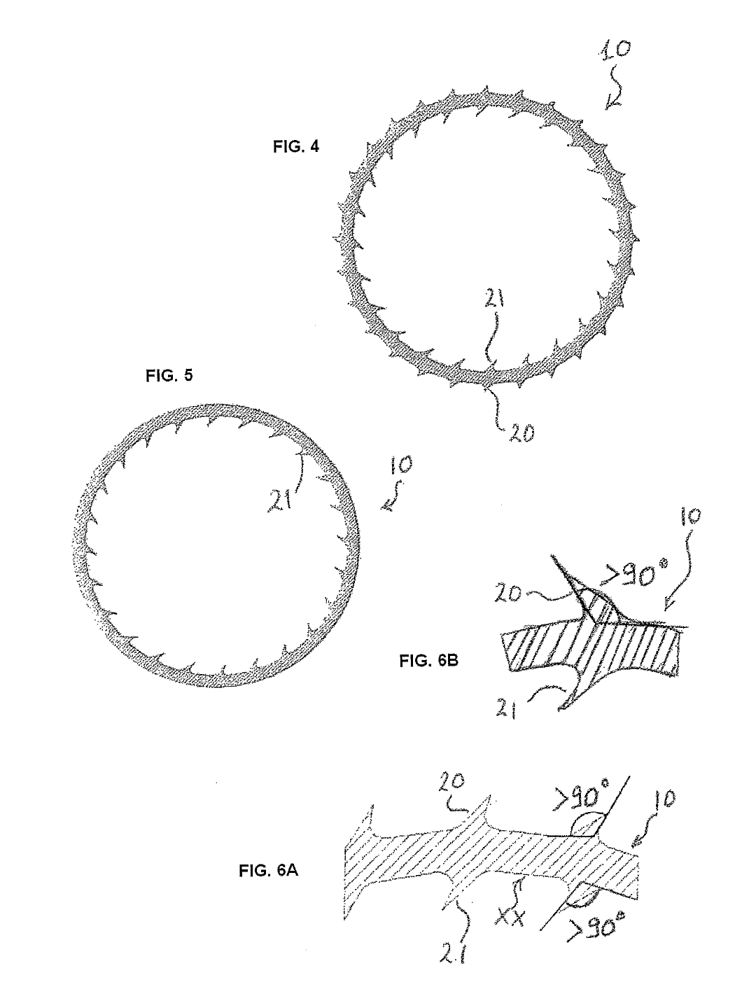

FIG. 4 shows a sectional view of a second embodiment of the support for an absorbing material through a perpendicular plane to said support axe, according to the present invention;

FIG. 5 shows a sectional view of a third embodiment of the support for an absorbing material through a perpendicular plane to said support axe, according to the present invention;

FIGS. 6a and 6b show a sectional view of features belonging to further embodiments of the absorbing material support, according to the present invention;

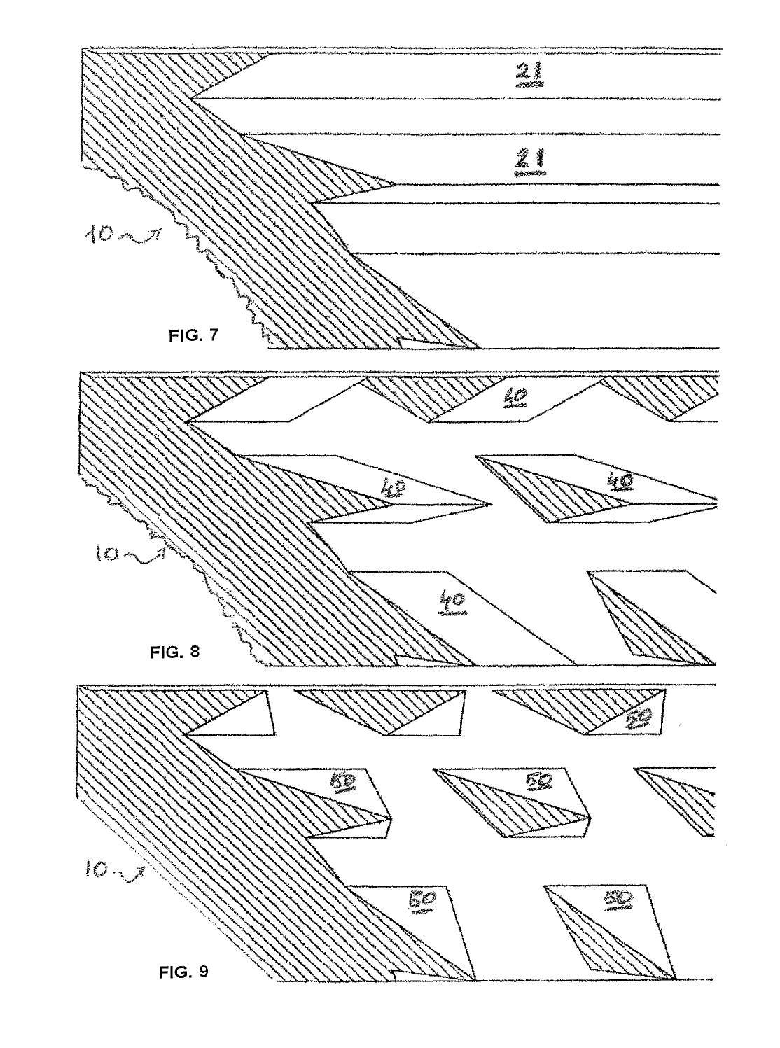

FIG. 7 shows a prospect view of a feature belonging to a first embodiment of the absorbing material support surface, according to the present invention;

FIG. 8 shows a prospect view of a feature belonging to a second embodiment of the absorbing material support surface, according to the present invention; and

FIG. 9 shows a prospect view of a feature belonging to a third embodiment of the absorbing material support surface, according to the present invention.

The support being the object of the present invention is indicated as a whole, in an exemplary embodiment, with reference 10.

In a preferred embodiment, the support for an absorbing material 10, as shown in FIGS. 6a and 6b, has on both its exterior and its interior wrapping surface (XX) some patterned anchoring elements 20 and 21, respectively.

In a further embodiment of the support (10) which is the object of the present invention, apart from the interior surface (XX), also the above-said exterior wrapping surface has anchoring elements (20) protruding with respect to said wrapping surface.

More preferably, the section of said anchoring elements (20) through a perpendicular plane to said exterior wrapping surface of said support (10), has at least one side forming an angle greater or equal to 90° with the external wrapping surface.

Said anchoring elements 21, or 21 and 20, have a section which is preferably triangular, in which a triangle side forms an angle greater or equal to 90° with the interior surface or the interior and exterior surfaces of support 10.

In a further embodiment of the support 10 which is the object of the present invention, either the exterior wrapping surface or the interior surface (XX), or both, have anchoring elements (20) and (21) on their surfaces preferably having triangular sections, and in which one side forms an angle greater or equal to 900 with its base coinciding with the exterior and/or interior wrapping surface(s) (XX) of support 10. More particularly, the anchoring elements (20) either those on the exterior wrapping surface (20) or those on the interior surface (XX) (21), or both, have a section which, independently from its shape, has at least one of its vertical sides top projecting on the base, thus forming an angle greater or equal to 90° on said base.

In a first feasible embodiment of the present invention surface, as shown in FIG. 7, the support is provided with anchoring elements 20 or 21 extending through the whole of its length.

In a second feasible embodiment of the present invention surface, as shown in FIG. 8, the anchoring elements 20 or 21 are interrupted transversally to the longitudinal extension of the support, in order to form tooth-shaped protrusions 40 having various lengths on its surface. Such transversal interruptions may further form anchoring elements in the form of points or thorns 50 placed regularly or irregularly on the interior surface or on the interior and exterior surfaces of support 10, as show in an exemplary way in FIG. 9.

Such anchoring elements 20 and 21, independently from their preferred shape, may be obtained during the extrusion o manufacturing phase of the pipe constituting the support, or alternatively obtained by engraving the external surface in order to remove part of the material.

Such anchoring elements 20 and 21 may also be obtained by applying protrusions having the above-said features to the interior or interior and exterior surface(s) of the support, by means of casting or gluing or mechanic fastening of different kinds, as nailing or screwing.

During operation of support 10 for wrapping an absorbing material to be used in printing machine cleaning plants, said support 10 is coupled to the knurled shaft of the cleaning plant by inserting said shaft into said support, which will be properly sized with a greater diameter than the knurled shaft.

The anchoring elements 21 on the interior surface of support 10 are properly patterned in order to allow an easy insertion and withdrawal of the knurled shaft with respect to the support 10 and, at the same time, to realize an optimal anchoring of support 10 to the exterior surface of said shaft during printing machine cleaning operations.

As a matter of fact, during said operations, the friction between said anchoring elements 21 and the knurled surface of said shaft opposes to the traction force applied by the printing cylinder on the absorbing material wrapped on said support 10.

The higher the value of the traction force applied by interaction between the printing cylinder and the absorbing material roll, the greater is said friction.

The support 10 which is the object of the present invention may be comprised of plastic, cardboard, wood or metal.

Preferably, support 10 is comprised of plastic materials, such as polythene, polyethylene, PVC, polyester, nylon or rubber, or a mixture thereof.

Another possibility for manufacturing the support 10 is the use of particularly rigid cardboards or plasticized cardboards or cardboards externally coated with properly treated plastic in order to allow forming continuous protrusions through the whole support 10 length, or transversally interrupted protrusions with reference to said length, in a regular or irregular way, so as to form teeth, points or thorns.

The support 10 may further be realized by the use of wood or metal, or by coupling said materials, being them in their turn usable in coupling with the above-said plastics and cardboards.

The support 10 for an absorbing material which is the object of the present invention has many important advantages with respect to those supports used into known art.

Firstly, the exterior protrusions directed contrarily to the absorbing material wrapping direction allow a crimping effect to the support on which it is wrapped that is such to improve its adhesion when the traction force applied on said material increases.

Secondarily, the exterior protrusions directed contrarily to knurled shaft rotation direction allow a support crimping to the shaft that is greater when the traction force applied on said shaft increases. The rotation of the core in the same direction of the protrusions will annul the crimping effect, allowing an easy insertion and withdrawal the shaft core.

A further advantage is to assure the possibility to apply a greater pressure during use of the cleaning roll, which may be fretted with a greater force against a surface to be cleaned.

Moreover, by means of the internal protrusions, modifications to the plant knurled shaft can be avoided, such shaft needing no support anchoring systems, such as splines, joints, mechanic links, and so on.

Finally, the interior protrusions allow the use of easily replaceable pre-wrapped supports, thus avoiding to waste time in wrapping the absorbing material on the plant knurled shaft and unwrapping it after use.

In this way, a further time saving, and thus of costs, is obtained, as well as a reduction of manual operations, part of which to be performed on the solvent-soaked and ink-soiled absorbing material.

From the above it is clear that the inventive concepts exposed are not limited to the application examples shown, but they can be advantageously applied to other similar applications.

The use range of the invention is not limited to the examples of the description above.

The present invention is thus subjected to many modifications and changes, all falling within the inventive concept expressed in the appended claims, while technical details could vary as needed.

1. A support for wrapping an absorbing material to be used in printing machine cleaning plants providing an exterior wrapping surface, characterized in that at least an interior surface of said support has anchoring elements protruding with respect to said interior surface.

2. The support according to claim 1, wherein a section of said anchoring elements, through a perpendicular plane to said interior surface of said support, has at least one side forming an angle greater or equal to 90° with the internal surface.

3. The support according to claim 2, wherein said section of said anchoring elements is substantially triangular, and at least one side of said anchoring elements forms an angle greater or equal to 90° with the internal surface of said support.

4. The support according to claim 3, characterized in that one or both side(s) of the triangle representing said support section has/have a curved pattern.

5. The support according to claim 3, characterized in that one or both side(s) of the triangle representing said support section has/have an interrupted pattern.

6. The support according to claim 1, wherein said anchoring elements extend through all the length of said the support and are spaced around the support.

7. The support according to claim 6, wherein said anchoring elements are transversally interrupted with respect to a longitudinal extension of the support, so as to form on its surface some protrusions in the form of teeth of variable length.

8. The support according to claim 7, wherein transversal interruptions form anchoring elements shaped as points or thorns placed on the interior surface of the support.

9. The support according to claim 7 wherein transversal interruptions form anchoring elements shaped as variously combined points or thorns.

10. The support according to claim 1, wherein said external wrapping surface has anchoring elements protruding with respect to said external wrapping surface.

11. The support according to claim 10, wherein a section of said anchoring elements has, through a perpendicular plane to said exterior wrapping surface of said support, at least one side that forms an angle greater or equal to 90° with the external wrapping surface.

12. The support according to claim 1, wherein both said exterior wrapping surface and the interior surface have on their surfaces some anchoring elements and which sections are triangular, and in which one of sides of the anchoring elements forms an angle greater or equal to 90° with the base coincides with a surface of the support.

13. The support according to claim 12, wherein the anchoring elements have a section such that, independently from their shape, at least one of the vertical sides of the anchoring elements with its top projected on the base forms an angle greater or equal to 90° with the base.

14. The support according to claim 1, wherein said anchoring elements have been obtained when extruding said support.

15. The support according to claim 1, wherein said anchoring elements have been obtained by engraving at least one surface of the support.

16. The support according to claim 1, wherein said anchoring elements have been applied by gluing, bonding or other kind of fastening to the interior surface or to the interior and exterior wrapping surfaces of the support.

17. (canceled)

18. (canceled)

19. A support for wrapping an absorbing material to be used in printing machine cleaning plants, the support in the form of a tube capable of fitting over a knurled shaft of the cleaning plant, the support providing an exterior wrapping surface for holding a roll of the absorbing material and also an interior surface with a greater diameter than the knurled shaft, the support characterized in that anchoring elements protrude from at least the interior surface to realize anchoring of the support to the shaft.

20. The support as in claim 19 wherein anchoring elements also protrude from the exterior wrapping surface to realize adhesion of the absorbing material to the support.
